(19) United States
(12) Patent Application Publication
(10) Pub. No.: US 2024/0010464 A1
(43) Pub. Date: Jan. 11, 2024

(54) METHOD FOR OPERATING AN ELEVATOR FOR MAINTENANCE

(71) Applicant: Inventio AG, Hergiswil (CH)

(72) Inventor: Valerio Villa, Colverde (IT)

(21) Appl. No.: 18/251,550

(22) PCT Filed: Nov. 9, 2021
(86) PCT No.: PCT/EP2021/081136

§ 371 Date: May 3, 2023

(30) Foreign Application Priority Data
Nov. 10, 2020 (EP) 20206759.1

(51) Int. Cl. B66B 5/00; B66B 5/02

(52) U.S. Cl. CPC B66B 5/0062; B66B 5/025; B66B 2201/406

(57) ABSTRACT

A method for operating an elevator for maintenance is performed on an elevator having a car, an elevator shaft, wherein the car is displaceable along the elevator shaft, a drive displacing the car, a plurality of shaft doors, at least one of the shaft doors being arranged at each of multiple floors including at least a lowermost floor and a uppermost floor, and an elevator control unit. The elevator control unit performs among others the method steps of: checking whether a person is within a predefined danger zone, wherein the predefined danger zone preferably is the elevator shaft; and switching from the maintenance mode back into a normal operation mode when there is no person within the predefined danger zone.

### FIELD

The present invention relates to a method for operating an elevator for maintenance. Furthermore, the present invention relates to an elevator configured for executing such a method, to a computer program product and to a computer-readable medium.

### BACKGROUND

An elevator comprises at least one car which may be displaced along an elevator shaft between multiple floors in a building using a drive engine. The car comprises at least one car door which may be opened and closed for providing and blocking access to the car, respectively. At each of the floors, at least one shaft door is provided which may be opened and closed for selectively providing or blocking access to the elevator shaft. The shaft doors are sometimes referred to as landing doors. As long as the car door is not coupled to a shaft door, the shaft door is generally locked in its closed state.

During maintenance of the elevator, a technician requires access to the elevator shaft in order to e.g. be able to inspect an integrity of components of the elevator comprised within the elevator shaft. For such purpose, in conventional elevators, the technician had to call the car to come near to one of the floors and set the elevator in state in which calls from the landing operation panels or a car operation panel were ignored. Then, the technician had to unlock the shaft door. For such unlocking, the technician had to use for example specific tools such as a triangular key. Then, the technician had to manually open the shaft door and e.g. get onto a roof of the waiting car. On the roof a control unit was typically provided. Using the control unit, the technician was able to control the drive engine while in maintenance mode for displacing the car to a desired location. Security measures had to be taken in order to guarantee that the technician was not hurt during such displacing action. For example, it had to be guaranteed that during the maintenance, the car was not driven to a location where the technician either on top of the car's roof or in the pit of the shaft was endangered. Finally, upon having completed the maintenance, the technician had to exit the elevator shaft and manually relock the associated shaft door.

Approaches for opening a locking of a landing door of an elevator are suggested in WO 2017/212105 A1 and WO 2017/212106 A1.

There may be a need for an alternative method for operating an elevator for maintenance. Particularly, there may be a need for a method of operating an elevator for maintenance which a safety level for the technician may be increased. Furthermore, there may be a need for an elevator, a computer program product and/or a computer-readable medium configured for implementing such a method.

### SUMMARY

These needs may be met with the subject-matter of one of the advantageous embodiments defined in the following specification.

According to a first aspect of the present invention, a method for operating an elevator for maintenance is proposed. Therein, the elevator comprises a car and an elevator shaft. The car is displaceable along the elevator shaft. The elevator further comprises a drive for displacing the car. It comprises a plurality of shaft doors, at least one of the shaft doors being arranged at each of multiple floors, including at least a lowermost floor and an uppermost floor. The elevator comprises an elevator control unit, wherein the elevator control unit performs the following steps:
the elevator control unit receives a start-maintenance-request sent by a technician, wherein the start-maintenance-request is preferably sent via a mobile electronic device,
the elevator control unit switches from a normal operation mode to a maintenance mode,
the elevator control unit receives a stop-maintenance-request sent by the technician, wherein the stop-maintenance-request is preferably sent via a mobile electronic device,
the elevator control unit checks whether a person is within a predefined danger zone, wherein the predefined danger zone preferably is the elevator shaft,
the elevator control unit switches from the maintenance mode back into the normal operation mode if there is no person within the predefined danger zone.

The method steps are preferably executed in the indicated order.

With this method, it may be prevented that the technician is still within the danger zone when the control unit switches back from maintenance mode to normal operation mode. It is guaranteed, that the elevator reassumes normal operation only when no person is within the danger zone and therefore at risk of being hurt by the elevator in its normal operation. Accordingly, the entire maintenance procedure may be rendered more secure, both for the technician as well as for other persons compared to the state of the art procedure, in which the system may be switched back to normal operation mode by one person outside of the shaft while another person is still within the shaft.

A start-maintenance-request may be only an information that maintenance is requested. In a preferred embodiment the start-maintenance-request preferably contains information on where the maintenance is intended to take place and on what kind of maintenance is planned, so that the depending on the nature of the start-maintenance-request the elevator control unit knows where to displace the car to and where to expect the technician to enter the shaft.

Danger zone means above and in the following a zone in which a person might be endangered during the normal operation of the elevator. A danger zone might be the elevator shaft as whole. Danger zones might also be specific parts of the elevator shaft, parts, such as the top of the car, the top of the elevator shaft, also referred to as head, or the bottom of the elevator shaft, also referred to as pit.

Implementing the method step of checking whether a person is within a predefined danger zone within the elevator control unit has the advantage that the check is performed within the same device as the device, in which all the functions, especially the displacement of the car is performed. Manually tricking the elevator into an unsafe condition by bypassing a remote part of a security system in a way that the control unit does not recognize the presence of people within the shaft is minimized. Said differently, the unit which judges whether a safe state is given and the unit which switches back to normal operation are implemented within the same unit, i.e. the elevator control unit.

A mobile electronic device may be a smartphone or any similar device. Using such a device to send the start-maintenance-request and/or stop-maintenance-request allows to ensure that only the authorized technician who possesses such a device and who is able to unlock the device with a password, via a fingerprint-reader or any other unlock feature is able to send those requests.

The maintenance mode above and in the following refers to a mode which differs from the normal operation mode at least in that calls entered by passengers at landing operation panels and/or a car operation panel are ignored. Accordingly, during maintenance mode, the elevator may not provide any transportation services to passengers. Thus, during maintenance mode, there is no risk of the car being displaced in reaction to a passenger's call.

During normal operation, a shaft door shall exclusively be opened when the elevator car is parked adjacent to a shaft door. In such situation, the car door and the respective shaft door are aligned. However, in order to enable maintenance, exceptions from this rule have to be implemented within the maintenance mode. Particularly, a technician shall be able to access the shaft through a shaft door while the car is not parked directly adjacent to a shaft door.

For safety reasons, the method described above and in the following assures that when the elevator is switched back from maintenance mode to normal operation mode, no person is within a danger zone, to which a person might have had access during maintenance mode.

In a preferred embodiment of the method for operating an elevator for maintenance, the step of checking that no person is within a predefined danger zone comprises the steps of:
capturing a pre-maintenance-status, preferably of the danger zone, of the elevator after the start-maintenance-request was received by the elevator control unit and before the elevator control unit switches form the normal operation mode to the maintenance mode; and/or
capturing a post-maintenance-status of the elevator after the stop-maintenance-request was received by the elevator control unit and before the elevator control unit switches from the maintenance mode back to the normal operation mode;
evaluating a difference between at least two out of the group of the pre-maintenance-status of the elevator, the post-maintenance-status of the elevator and a predefined value for the pre-maintenance-status and a predefined value of the post-maintenance-status, and
concluding that no one is in the predefined danger zone if the evaluated difference and/or differences is below a predefined threshold, preferably within ±5%, especially preferred within ±2% of each other.

Capturing a pre-maintenance-status refers above and in the following to using a sensor or a set of sensors of one or several types to capture a status of the elevator before the maintenance mode is entered. Similarly, capturing a post-maintenance-status of the elevator refers above and in the following to using a sensor or a set of sensors of one or several types of the elevator to assess a status of the elevator. Capturing in this context means recording the status of the above-mentioned sensors. Capturing the pre-maintenance mode therefore means recording the value of one or several sensors before the control unit switches form normal operation mode to maintenance mode. Capturing the post-maintenance-status means recording values of one or several sensors before the control unit switches from normal operation mode to maintenance mode.

In order to conclude that no person is within the predefined danger zone in an embodiment, the pre-maintenance-status of the elevator and the post-maintenance-status of the elevator are evaluated, meaning are compared, meaning a difference between the two statuses is evaluated. In another embodiment, the pre-maintenance-status is compared to a predefined value of the pre-maintenance-status. In another embodiment the post-maintenance-status is compared to a predefined post-maintenance-status. In other embodiments any combination of the mentioned embodiments is implemented.

Concluding that no one is in the predefined danger zone if the evaluated difference and/or differences is below a predefined threshold, preferably within ±5%, especially preferred within ±2% of each other. The difference might for example be a difference in kilograms if a weight is measured, or a difference in the state of the pixels of a captured snapshot or any representative part of it, or an amount of difference in objects identified within a snapshot.

By doing so it can be concluded that compared statuses resemble each other enough to assume that nothing has changed within the danger zone to a degree where safe operation of the elevator would not be possible anymore. Particularly, it is concluded that if the difference is below a predefined threshold, no human being is within the danger zone.

The embodiment in which the pre-maintenance-status and a post-maintenance status are captured and compared is based on the assumption that the elevator is in a safe condition before the elevator switches from a normal operation mode to a maintenance mode. By capturing the relevant elements of that safe normal operation mode and then comparing it to a captured status of the same part of the elevator before the mode is switch back to the normal operation, the control unit is enabled to assess whether during maintenance changes occurred, for which a safe normal operation seems unlikely. The comparison of a pre-maintenance-status and a post-maintenance-status of a predefined danger zone is an attempt to only check the space and timewise relevant changes and therefore is an efficient way to ensure that no person is endangered when the elevator operates normal again. Changes within the elevator, such as for example the aging and accumulation of dirt on sensors and a thus experienced drift of the output values of them becomes irrelevant in assessing whether somebody is within the danger zone. The two statuses are captured within a very short period compared to the life span of an elevator. During this period no changes due to wear should occur. Therefore, not only the effort to detect people within the danger zone is decreased but also the accuracy of it is increased. Small changes within an elevator, such as upgrades in or on the car but outside of the danger zone do not require an adaption. This embodiment therefore allows a more efficient and more secure method for operating an elevator for maintenance.

In a preferred embodiment of the method for operating an elevator for maintenance, the capturing of the pre-maintenance-status and the post-maintenance-status of the elevator comprises:
measuring a pre-maintenance- and/or post-maintenance-load within or of the car and storing it in the elevator control unit.

For most maintenance work (all maintenance work not performed in the pit), the car is driven to a position where its car door is not aligned with the shaft door but in which its roof is accessible from the shaft door. For example, the car may be displaced and stopped such that its roof is next to a lower end of the shaft door. Accordingly, when the technician enters the elevator shaft, he may step onto the roof of the parked car. During the maintenance, the technician works from car roof. In this condition a load measurement unit of the elevator will measure on top of the usual system weight also the weight of the technician. Measuring the load of the car before the maintenance mode and after the request for switching back to normal operation mode is received can thus be used to see whether additional weight has been added to the car, indicating that a person could still be on the car roof. Furthermore, any tools which the technician might have brought with him onto the roof of the car and have been left there would result in a change of the car's weight and therefore could be detected too.

As an alternative, the post-maintenance-load and/or pre-maintenance-load might be compared to a predefined value. Such a predefined value could be a load measured right after the installation of the car or a nominal value of the car.

The method increases the safety without the need of any additional sensors, as measuring the load of the car is a necessary measurement during the operation of the elevator, for example to determine a pre-torque-value. Therefore, a load measurement sensor will be available in the elevator anyway. Making use of that already available sensor for ensuring that a technician is not within a predefined danger zone, is a simple and efficient way to increase the security during a method for operating an elevator for maintenance.

According to a preferred embodiment of the method for operating an elevator for maintenance, the step of capturing of the pre-maintenance-status and/or the post-maintenance-status of the elevator comprises:
capturing a snapshot of the elevator shaft with a classical camera, a ToF-camera, a thermographic camera and/or a lidar system.

A snapshot above and in the following means the recording of one or several of the above mentioned cameras/lidar at the certain point in time.

A time-of-flight camera (ToF-camera) is a range imaging camera system that employs time-of-flight techniques to resolve distance between the camera and the subject for each point of the image, by measuring the round trip time of an artificial light signal provided by a laser or an LED. A thermographic camera (also known as infrared camera or thermal imaging camera) is a device that creates an image using infrared radiation, similar to a common camera that forms an image using visible light. Lidar is a method for measuring distances (ranging) by illuminating the target with laser light and measuring the reflection with a sensor. Differences in laser return times and wavelengths can then be used to make digital 3-D representations of the target. All these means are well known to the person skilled in the art.

Comparing the pre-maintenance-snapshot and the post-maintenance-snapshot means above and in the following that the snapshots as a whole are compared or, alternatively, that certain objects, for example of certain sizes or with certain colors or reflection patterns are identified to then be compared to the objects identified in the other snapshot.

Using snapshots before and after the maintenance helps to identify changes within the predefined danger zone occurring during maintenance. The use of such snapshots therefore can be used to assess whether it is safe to switch back to normal operation, either alone or in combination with measurements of other sensors such as a load measurement sensor.

The camera(s)/lidar might be located in a part of the shaft, for example in a pit and/or in the head of the shaft or might be attached to the car, for example to the bottom and/or top of the car so that the areas where a person could be endangered can be monitored.

The advantage of using a ToF-camera, a thermographic camera and/or a lidar system instead of a classical camera and/or in combination with a classical camera is that these cameras are much less susceptible to pollution. The dust and dirt within the elevator shaft could over time impact the vision of a classical camera. Any of these cameras is much less prone to such pollution. Such cameras therefore increases the security of the system and also reduces the maintenance/cleaning work required for keeping the system in safe operation.

In a preferred embodiment of the method for operating an elevator for maintenance, the step of verifying that no person is within a predefined danger zone comprises the steps of:
verifying the technician's presence within the car and/or on a floor after the elevator control unit receives a start-maintenance-request of a technician and before the elevator control unit switches from the normal operation mode to a maintenance mode, and/or
verifying the technician's presence within the car and/or on a floor after the elevator control unit receives a stop-maintenance-request of the technician and before the elevator control unit switches from the maintenance mode back into the normal operation mode.

Verifying the presence means above and in the following concluding that the technician is in the proximity of the specific part, i.e. within the car or on a floor to a degree where it is possible to conclude that the technician is outside of the elevator shaft. If a technician detected to be in the car, for example by a camera (for example as described above) or by any other sensor, such as a near-field communication sensor that allows to conclude that a human is inside the car, it is safe to assume that it is impossible for him to also be present within the danger zone, i.e. within the elevator shaft. Similarly, this is true if it is possible to identify the technician's presence on a floor. This might be done by a camera or any other sensor, such as a near-field communication sensor, etc. Such a sensor might be part of a landing operating panel or any other parts belonging to the elevator on a floor level.

Detecting the presence of the technician within the car or on a floor is a relatively easy, safe and reliable way of assuring that the technician is not in the shaft anymore. In many elevators, such sensors will be implemented within the car and/or on the floor anyway, as the presence of people in the car or on the floor is an information that is used in other parts of the elevator control.

Switching between the normal operation mode and the maintenance mode only after verifying the presence of the technician in the car or on the floor might be an additional safety element to assure that the maintenance does not endanger people. Assuring the presence of the technician within the car or on the floor before the maintenance mode is entered, is a way of making sure that the elevator is not switched into the maintenance mode without an authorized person being close to the elevator. Assessing the presence of a technician within the car or on the floor before the mode of operation is switched back from maintenance mode to normal mode is a safe way of making sure that the technician who initiated the maintenance mode is now back out of the shaft and within one of the two mentioned areas before the normal operation resumed.

In a preferred embodiment of the method for operating an elevator for maintenance verification the technician's presence in the car and/or on a floor is performed by identifying the technician by means of:
displaying a code on a screen in the car and/or on the floor, which the technician has to scan with a mobile electronic device, and/or
using a camera and/or a near field communication device in the car and/or on the floor to identify the technician.

Above and in the following displaying a code, which is then scanned by the technician might be implemented as displaying a changing code, wherein the pattern of the changing code is known to the App the technician is supposed to use to scan the code. The App can assess whether the code that it is scanned is within the pattern that it should be. Using a dynamic code has the advantage that the code cannot be copied and then scanned from any other location, for example inside of the shaft from another phone, on which a picture of the static code is stored. With a dynamic code, the App can conclude that the person, who scanned the code is present close to the displayed code in the moment of scanning.

The use of a camera in combination with facial recognition or any other kind of identification, such as iris detection and/or a near field communication device which only couples to a specific predetermined other device alternatively or further helps to conclude that the authorized person is within close proximity of that camera and/or near field communication device.

In a preferred embodiment, the method for operating an elevator for maintenance, the start-maintenance-request of a technician is a request to enter the elevator shaft at a specific shaft door. The method of this embodiment comprises the step of displacing the car to a predefined position in proximity of the specific shaft door.

By requesting the maintenance to take place at a specific floor, the car can be displaced to a predefined position in proximity of that floor. This allows for a method for operating an elevator for maintenance, in which during the maintenance only a predefined number of locations will be used. Such a method will for example include a predefined position for the car for maintenance at each of the floors. This has the advantage that a car does not have to be displaced during maintenance at all. If the technician after finishing the maintenance at a specific floor needs to do more maintenance at another floor, he would leave the shaft, check out of the current maintenance mode by sending a stop-maintenance request and then enter a new start-maintenance request for the next maintenance work, e.g. at a different floor. Before the car is driven to the other floor, the maintenance mode would be left and therefore the danger zone would be checked for people. This allows to then displace the car to the other floor, for which the technician requested maintenance. This way a method for operating an elevator for maintenance is implemented, in which a manual displacement of the car within the shaft during the maintenance mode is not needed. Therefore, the security of the method for operating an elevator for maintenance is increased, as endangering people within the shaft due to displacement of the car during the maintenance mode is avoided.

The predefined position in proximity of the specific shaft door can be any position, in which the car facilitates the maintenance on that specific floor. This could for example be a position in which the roof of the car is on the same height as the floor, so that the technician can conveniently walk on top of the roof of the car. For the lowermost floor, such a predefined position in proximity of the specific shaft door could be a position in which the car does not block the entrance to the pit. In another similar maintenance-request, for example to do maintenance work on a bottom of the car, the car could be displaced to a position in which it only partially blocks the entrance on the lowermost floor and therefore allows the technician to enter the pit but still being able to reach the lowermost part of the car comfortably. In another exemplary start-maintenance-request, the technician can request for maintenance to be done at the head of the elevator shaft. In this case, the car could be displaced to a position in which the roof of the car is at a certain height of the entrance of the uppermost floor, so that the technician can step onto the car roof and reach the components in the head of the elevator shaft.

In a preferred embodiment of the method for operating an elevator for maintenance, the method further comprises the step of restricting the displacement of the car in solely a
an upward direction if the maintenance mode was requested at the lowermost floor, and/or
a downward direction if the maintenance mode was requested at the uppermost floor after the stop-maintenance-request was received by the elevator control unit.

In this embodiment, the security of the method for operating an elevator for maintenance is further increased. If the maintenance was requested at the lowermost floor, the technician will be doing maintenance work in the pit. The resulting danger to crush the technician by moving the elevator car is avoided by initially only allowing an upward movement. As a next step it could be required for the technician to identify himself at the next higher floor, i.e. at the first floor within the car. In such a case, the method for operating the elevator for maintenance could look like the following:
the start-maintenance-request is sent with the information that the technician wants to perform maintenance in the pit,
the elevator control unit displaces the car to a position in which the entrance at the lowermost floor is at least partially cleared so that a technician can comfortably enter the pit,
the technician enters the pit and performs the needed maintenance work,
the technician leaves the pit in the same way he entered it after the maintenance work is performed,
being outside of the elevator shaft the technician requests to stop the maintenance and a stop-maintenance-request is sent to the elevator control unit,
it is checked whether a person is within a predefined danger zone by any of the means described above or in the following and/or
by displacing the elevator car in an upward direction to the first floor for the technician to be able to enter the car there,
the technician enters the car, the elevator control unit detects by any of the above-described means the presence of the technician within the car,
knowing that the technician, who initially requested the maintenance is now within the car one floor above the pit, the elevator control unit concludes that the technician is not in the danger zone, i.e. pit anymore,
the elevator control unit switches from maintenance mode back to a normal operation mode.

A similar way of exiting the maintenance mode can be performed if maintenance is requested at the uppermost floor. In this case, the car is restricted to only be able to move downward from the maintenance position. The car can then be stopped at the floor below the uppermost floor. This way the technician who requested the maintenance mode and had left the head before sending a stop-maintenance-request can identify himself within the car. After the elevator control unit identified the technician's presence within the elevator car, the control unit can conclude that the technician is not in the head of the elevator shaft anymore and therefore a safe normal operation mode can be resumed.

In another embodiment of the method, the displacement of the car is restricted to a downward displacement for any start-maintenance-request except for the request to do maintenance in the pit.

For any other maintenance work within the elevator shaft except the one in the pit it can be assumed that it is the safest to displace the car in a downward direction, as for all of these maintenance-requests the technician will be performing the work on top of the car roof.

In a preferred embodiment of the method for operating an elevator for maintenance as described above and in the following, at least one, preferably all of the shaft doors, have an associated active door drive for opening and closing the shaft door and/or an active door lock for locking and unlocking the shaft door. The method further comprises the steps of:
unlocking and/or opening the specific shaft door by means of the active door lock and/or the active door drive, respectively, so that the technician can access the elevator shaft after the maintenance mode was entered, and/or
closing and/or locking the specific shaft door by means of the active door drive and/or the active door lock, respectively, so that the technician cannot access the elevator shaft anymore before the maintenance mode is left.

The use of active door drives/active door locks allows to use the elevator shaft door as an additional security element. The shaft door can be opened by the elevator control unit once the elevator control unit knows that the car has arrived at the predefined position and the elevator shaft therefore is safe to be entered at a specific floor, on which then the elevator control unit unlocks/opens the shaft door via the active door lock/active door drive. At the same time or in addition, an active door drive/active door lock also allows to close a specific elevator shaft door once a request to stop maintenance is received by the elevator control unit. This allows the elevator system to make sure that whatever state within the elevator shaft is present at this point in time cannot be changed from the outside of the elevator shaft anymore. The elevator control unit can then perform the safety check and verify that no person is within the predefined danger zone. If no person is within the predefined danger zone, the elevator control unit switches back to the normal operation mode.

In a preferred embodiment also the car door is equipped with an active door drive and/or lock.

In a preferred embodiment, the method as described above and in the following may further comprise the step of assuring that the car is empty after the elevator control unit receives a start-maintenance-request sent by the technician and before the elevator control unit switches from a normal operation mode to a maintenance mode.

This allows to ensure that no passenger is trapped within the elevator car during the maintenance mode. Means to verify the people inside the car are known to the person skilled in the art.

In a preferred embodiment of the method for operating an elevator for maintenance, the elevator control unit prevents the car from being displaced, and/or an elevator brake, preferably a car brake, is engaged before the technician is granted access to the shaft.

In this embodiment, the method is made more secure by either disabling the drive to be activated via the control unit and/or by blocking any movement of the car during the maintenance mode by engaging the brake before the technician enters the shaft. With any of the above it can be assured that once the technician has entered the shaft for maintenance, the elevator car will not be displaced in any direction.

In a preferred embodiment of the method described above and in the following, the method further comprises the step of:
initiating a verification of the braking capability after the maintenance mode was left and/or before the maintenance mode is entered by performing a static brake test.

Both for a safe normal operation mode and a safe maintenance mode, the proper functioning of the elevator brake is required. In the normal operation mode, the brake is required to stop the car at any of the floors. During the maintenance mode, the brake might be required to ensure that the car stays safely at a predefined position. The brake's functioning should therefore be checked whenever it is switched between the two modes.

In a preferred embodiment the method for operating an elevator for maintenance at any floor but the lowermost floor comprises the steps of:
a technician reaches a level other than the lowermost floor, on which he wants to perform maintenance;
the technician sends a start-maintenance-request for a specific maintenance procedure at that floor to the elevator control unit via a mobile electronic device;
the elevator control unit controls the car to be displaced to that level;
the elevator control unit opens the shaft and car doors by controlling an active door drive of the shaft door and controlling an active door drive of the car door;
the technician enters the car to verify that the car is empty;
while the technician is in the car, the elevator control unit confirms his presence;
the technician leaves the car and the elevator control unit closes the shaft door via the active door drive of the shaft door and the car door via the active door drive of the car door;
the elevator control unit controls the car to be displaced to a predefined maintenance position in proximity of that level;
the elevator control unit activates a brake, preferably a car brake;
the elevator control unit measures and stores a pre-maintenance-load, preferably measured by a car load measurement cell;
the control unit opens the landing door via the active door drive of the shaft door;
the technician enters the shaft to perform maintenance;
the technician leaves the shaft once the maintenance is done and sends a stop-maintenance-request to the elevator control unit via the mobile electronic device once he is outside of the shaft;
the elevator control unit closes the shaft door by controlling the active door drive of the shaft door;
the elevator control unit measures a post-maintenance-load and compares the value to the stored pre-maintenance-load;
if the values are within a predefined range, the elevator control unit controls the car to be displaced to the next lower floor;
the elevator control unit opens the shaft and car doors by controlling the active door drive of the shaft door and controlling the active door drive of the car door, respectively;
the technician enters the car to confirm his presence inside the car;
the technician leaves the car and the elevator control unit closes the shaft door via the active door drive of the shaft door and the car door via the active door drive of the car door;
the elevator control unit performs a static brake test;
if the brake test is passed, the elevator control unit switches from the maintenance mode back into normal operation mode.

In a preferred embodiment the shaft and/or the car door additionally comprise an active door lock, which unlocks the respective door before it is opened by the respective active door drive and locks the respective door after the door was closed by the respective door drive.

In a preferred embodiment the method for operating an elevator for maintenance at the lowermost floor comprises the steps of:
a technician reaches the lowermost floor, on which he wants to perform maintenance;
the technician sends a start-maintenance-request for a specific maintenance procedure at that floor to the elevator control unit via a mobile electronic device;
the elevator control unit controls the car to be displaced to that level;
the elevator control unit opens the shaft and car doors by controlling an active door drive of the shaft door and controlling an active door drive of the car door;
the technician enters the car to verify that the car is empty;
while the technician is in the car, the elevator control unit confirms his presence;
the technician leaves the car and the elevator control unit closes the shaft door via the active door drive of the shaft door and the car door via the active door drive of the car door;
the elevator control unit controls the car to be displaced to a predefined maintenance position in proximity of that level;
the elevator control unit activates a brake, preferably a car brake;
the elevator control unit measures and stores a pre-maintenance-load, preferably measured by a car load measurement cell;
the control unit opens the landing door via the active door drive of the shaft door;
the technician enters the shaft to perform maintenance;
the technician leaves the shaft once the maintenance is done and sends a stop-maintenance-request to the elevator control unit via the mobile electronic device once he is outside of the shaft;
the elevator control unit closes the shaft door by controlling the active door drive of the shaft door;
preferably the elevator control unit measures a post-maintenance-load and compares the value to the stored pre-maintenance-load;
if the values are within a predefined range, the elevator control unit controls the car to be displaced to the next upper floor, i.e. the first floor;
the elevator control unit opens the shaft and car doors by controlling the active door drive of the shaft door and controlling the active door drive of the car door, respectively;
the technician enters the car to confirm his presence inside the car;
the technician leaves the car and the elevator control unit closes the shaft door via the active door drive of the shaft door and the car door via the active door drive of the car door;
the elevator control unit performs a static brake test;
if the brake test is passed, the elevator control unit switches from the maintenance mode back into normal operation mode.

In a preferred embodiment the shaft and/or the car door additionally comprise an active door lock, which unlocks the respective door before it is opened by the respective active door drive and locks the respective door after the door was closed by the respective door drive.

According to a second aspect of the invention, an elevator is proposed, the elevator being configured to one of executing and controlling the method according to an embodiment of the first aspect of the invention.

In a preferred embodiment the elevator comprises a car being displaceable along an elevator shaft, a drive for displacing the car, an elevator control unit, a plurality of shaft doors, at least one shaft door being arranged at each of multiple floors, preferably each of the shaft doors having an associated active door drive for opening and closing the shaft door and/or active door lock, which can be enabled/disabled by the elevator control unit. The elevator is configured to executing the method as described above and in the following.

An active door lock preferably is a door lock, with a rod and an actuator, preferably an electromagnetic actuator, to move the rod from a locking position into an unlocked position. The active door lock in a preferred embodiment includes a sensor to detect the locked and unlocked position.

In a preferred embodiment the elevator control unit, or at least as a part of it, of the elevator as described above and in the following is configured to fulfil SIL3 requirements.

In the elevator, all components participating in controlling the displacement of the car and/or opening the shaft doors may have to fulfil high safety requirements as defined in the SIL3 (Safety Integrity Level 3) standard. Accordingly, it may be guaranteed that no malfunctions in one of the components may result in creating potentially dangerous situations such as displacing the car while a technician is within the elevator shaft or opening a shaft door while no car has been driven to the predefined position close to the shaft door.

The elevator control unit or any part of it may be programmable. They may have for example a processor for executing computer-readable instructions and/or processing data and a memory for storing the instructions and/or data. Optionally, the door controller may be implemented within the elevator control unit or separate from it. In the latter case, two control units are connected with a data communication link.

According to a third aspect of the invention, the computer program product comprises computer-readable instructions which, when performed by a processor in an elevator according to an embodiment of the second aspect of the invention, instructs the elevator to one of executing and controlling the method according to an embodiment of the first aspect of the invention. Alternatively, the computer program product comprises computer-readable instructions which, when performed by a processor in a mobile data communication device, instructs the mobile data communication device to transmit one of the requesting signal and the finalizing signal for triggering an elevator according to an embodiment of the second aspect of the invention to one of executing and controlling the method according to an embodiment of the first aspect of the invention.

In a preferred embodiment the computer program product comprises computer readable instructions which, when performed by a processor in an elevator as described above and in the following instructs the elevator to one of executing and controlling the method as described above and in the following. Or, alternatively, the computer program product comprises computer readable instructions which, when performed by a processor in a data communication device, instructs the data communication device to transmit a maintenance-request for triggering an elevator as described above and in the following to executing the method as described above and in the following.

A computer program product may be a form of an application (“App”) and may be used to instruct a mobile data communication device such as a smartphone to transmit one of the requesting signal and the finalizing signal for triggering an elevator such that the elevator executes or controls the method proposed herein.

The computer program product comprising the computer-readable instructions may be in any computer-readable language. Upon executing the computer-readable instructions, the elevator control unit performs or controls steps of the method proposed herein.

According to a fourth aspect of the invention, a computer-readable medium is proposed. The computer-readable medium has stored thereon a computer program product according to an embodiment of the third aspect of the invention.

A computer-readable medium comprising the computer program product described above stored thereon may be any portable computer-readable medium such as a CD, a CVD, a flash memory, etc. for transient or non-transient data storage. Alternatively, the computer-readable medium may be a computer or part of a computer network such as a cloud or the Internet, such that the computer program product may be downloaded therefrom.

It shall be noted that possible features and advantages of embodiments of the invention are described herein partly with respect to a method for operating an elevator for maintenance and partly with respect to an elevator configured for implementing such method. One skilled in the art will recognize that the features may be suitably transferred from one embodiment to another and features may be modified, adapted, combined and/or replaced, etc. in order to come to further embodiments of the invention.

In the following, advantageous embodiments of the invention will be described with reference to the enclosed drawing. However, neither the drawing nor the description shall be interpreted as limiting the invention.

### DESCRIPTION OF THE DRAWINGS

FIG. 1 shows an elevator configured for executing a method for operating the elevator for maintenance according to an embodiment of the invention.

The FIGURE is only schematic and not to scale. Same reference signs refer to same or similar features.

### DETAILED DESCRIPTION

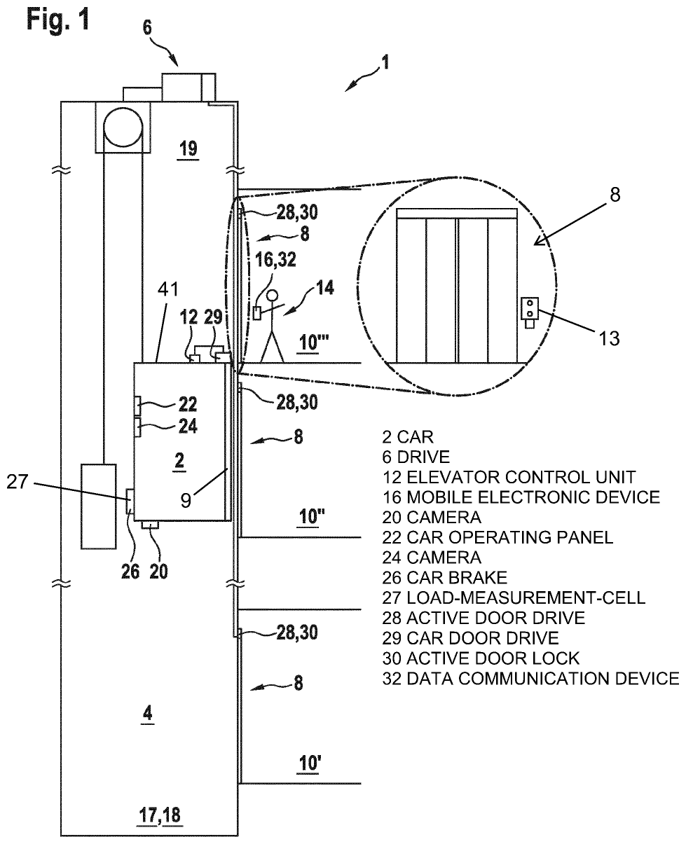

FIG. 1 shows an elevator 1. The elevator 1 is shown in a side view. Furthermore, a portion of the elevator 1 is shown in a front view, as visualized in a partial view inside a dashed frame line.

The elevator 1 comprises a car 2 which is displaceable along an elevator shaft 4. The elevator car 2 is held and displaced by a suspension traction means such as a rope or a belt. At its opposite end, the suspension traction means is coupled to a counterweight. The suspension traction means is driven by a drive 6. The drive 6 is controlled by the elevator control unit 12.

The elevator car 2 comprises a car door 9 for opening and closing an access to the elevator car 2. The car door 9 may be opened and closed actively by a car door drive 29. The car door drive 29 is controlled by the elevator control unit 12.

At each of multiple floors 10′, 10″, 10′″ at least one shaft door 8 is provided. The shaft door 8 may be opened and closed for granting or blocking access to the elevator shaft 4. The elevator 1 presented herein comprises an active door drive 28 at each of the shaft doors 8 for actively opening and closing the respective shaft door 8 by laterally displacing shaft door blades. Each of the door drives 28 is controlled by the elevator control unit 12. It is to be noted, that for reasons of a simpler formation, the term door drive 28 shall refer herein only to the shaft doors 8, not to the car door 9 (which is equipped with a car door drive 29). An active door lock 30 can be provided for locking and unlocking the shaft doors 8.

Furthermore, at each of the multiple floors, a landing operation panel 13 is provided in proximity to the shaft door 8. For example, such landing operation panel 13 may comprise one or more push buttons which may be actuated by passengers for calling the car 2 to come to their floor.

During normal operation of the elevator 1, the elevator control unit 12 controls the drive 6 for displacing the car 2 to one of the floors in response to a passenger's call provided by actuating one of the landing operation panels 13. Therein, the drive is controlled such that the car 2 is stopped at the landing position such that its car bottom is substantially on the same height as a bottom at the floor at which the car 2 shall collect or deliver passengers.

For maintenance purposes, the normal operation of the elevator 1 has to be temporarily interrupted. For such purpose, according to the method proposed herein, the technician 14 may approach the elevator 1 at one of the floors, such as for example the uppermost floor 10′″. Upon being close to the shaft door 8 at this floor 10′″, the technician may send a request for maintenance. Such a request is then received by the elevator control unit 12.

When the elevator control unit 12 has received a maintenance-request sent by the technician 14, the drive 6 will control the displacement of the car 2 to a position such that a roof 41 of the car 2 is adjacent to the shaft door 8 at the floor at which the maintenance work requested in the maintenance-request has to be performed (for example the uppermost floor 10′″, as shown in FIG. 1). For this maintenance-request, the head 19 equals the predefined danger zone 18. Subsequently, the elevator control unit 12 controls the door drive 28 at the respective floor 10′″ to actively open the associated shaft door 8. The technician 14 may enter the elevator shaft 4 by stepping on top of the roof 41 of the waiting car 2. At such location, the technician 14 may inspect, modify, repair or replace various components of the elevator 1, such as for example car guide shoes, parts of the elevator control unit, a front bracket fixation, the suspension traction means, a load measuring system and connectors at the counterweight side as well at the car side, counterweight guide shoes, shaft information, a deflection pulley, and/or other components.

Upon having completed the maintenance, the technician 14 may leave the elevator shaft 4 through the opened shaft door 8. The technician 14 may then send a stop-maintenance-request with a data communication device 32 such as his mobile electronic device 16 which may be received by the elevator control unit 12. Upon receiving the stop-maintenance-request, the elevator control unit 12 may control the door drive 28 of the opened shaft door 8 to close this shaft door 8. The elevator control unit 12 displaces the elevator car in an downward direction after the elevator control unit 12 has closed the shaft door 8. As a next step, the technician 14, who at this time is supposed to be outside of the shaft 4, has to identify himself within the car being positioned one floor 10″ below the uppermost floor 10′″. The elevator control unit 12 therefore opens the respective shaft doors and the car doors so that the technician 14 can enter the car 2 from the floor 10″ and identify himself for example at the car operating panel 22, which may include a camera 24. After this identification, the elevator control unit 12 knows that the technician 14, who requested maintenance is not inside the shaft anymore and therefore not within the predefined danger zone, i.e. within the head 19 and safely switches back to normal operation mode.

In exemplary embodiment a load-measurement-cell 27 implemented at the car-brake 26 may be used to capture a pre-maintenance-status, i.e. pre-maintenance-load-measurement before the maintenance mode is entered and post-maintenance-status, i.e. a post-maintenance-load-measurement before the maintenance mode is left. Before displacing the car to the next lower floor 10″ (see paragraph above) the elevator control unit 12 compares the two load measurements to conclude that they are within a predefined range, e.g. 5% of each other. Only if this is concluded, the car 2 is then moved to the lower floor 10″, where the method continues as described above, i.e. by identification of the technician 14 inside the car 2.

When the maintenance-request is such that maintenance at the lowermost floor 10′ is requested, the drive 6 will displace the car 2 based on a control of the elevator control unit 12 to a position above the lowermost floor 10′, i.e. such that the car bottom is sufficiently above a pit 17 of the elevator shaft 4, for allowing the technician 14 to enter such a pit 17. For this maintenance-request, the pit 17 equals the predefined danger zone 18. Subsequently, the elevator control unit 12 controls the door drive 28 of the lowermost floor 10′ to actively open the associated shaft door 8. The technician 14 may then enter the pit 17. In the pit 17, the technician may inspect, modify, repair or replace various components of the elevator 1.

Upon having received the request for maintenance (start-maintenance-request), the elevator control unit 12 switches to maintenance mode. In such maintenance mode, calls entered by passengers for example one of them at landing operation panels 13 at any of the other floors or at a car operation panel 22 are ignored. Furthermore, any displacement of the car 2 is prevented as long as the elevator control unit 12 is in the maintenance mode.

In an exemplary, the technician 14 may use a mobile electronic device 16 such as a smartphone to generate and transmit data forming the maintenance-request. For such purpose, a specific application may be programmed and uploaded to the mobile electronic device 16. The electronic mobile device 16 may send electromagnetic waves encrypting the maintenance-request. The electromagnetic waves may be received by a suitable sensor being part or being connected to the elevator control unit 12. Alternatively, the communication link between the mobile electronic device 16 and the elevator control unit 12 could also be established via a server, e.g. a cloud.

Upon having completed the maintenance, the technician 14 may leave the elevator shaft 4 through the opened shaft door 8. The technician 14 may then send a stop-maintenance-request with his mobile electronic device 16 which may be received by the elevator control unit 12. Upon receiving the stop-maintenance-request, the elevator control unit 12 may control the door drive 28 of the opened shaft door 8 to close this shaft door 8. The elevator control unit 12 displaces the elevator car in an upward direction after the elevator control unit 12 has closed the shaft door 8. As a next step, the technician 14, who at this time is supposed to be outside of the shaft 4, has to identify himself within the car being positioned at the floor 10″. The elevator control unit 12 therefore opens the respective shaft doors and the car doors so that the technician 14 can enter the car 2 and identify himself for example at the car operating panel 22, 24. After this identification, the elevator control unit 12 knows that the technician 14, who requested maintenance is not inside the shaft anymore and therefore not within the predefined danger zone, i.e. within the pit 17 and safely switches back to normal operation mode.

In exemplary embodiment a camera 20 may be implemented at the bottom of the car and may be used to capture a pre-maintenance-status, i.e. pre-maintenance-snapshot before the maintenance mode is entered and post-maintenance-status, i.e. a post-maintenance-snapshot before the maintenance mode is left. Before displacing the car to the next floor 10″ (see paragraph above) the elevator control unit 12 compares the two snapshots to conclude that they resemble each other to a degree that the presence of a person in the pit can be negated. Only if this is concluded, the car 2 is then moved to the upper floor 10″, where the method continues as described above, i.e. by identification of the technician 14 inside the car 2.

With the method and elevator 1 proposed herein, maintenance of the elevator 1 may be substantially simplified and may be made more secure. Upon sending a start-maintenance-request, the shaft door 8 at the floor where the technician 14 has requested maintenance may be opened actively and automatically. Furthermore, the car 2 has already previously been driven to a suitable location. As during maintenance mode, no further displacement of the car 2 is allowed and risk of injury for the technician is minimized. Furthermore, there is no need for any control unit on the car roof or in the pit 17. Generally, there is also no need for any toe guard on the car roof 41 and/or for an apron on a car sill. Accordingly, costs for such equipment may be saved.

Finally, it should be noted that the term “comprising” does not exclude other elements or steps and the “a” or “an” does not exclude a plurality. Also elements described in association with different embodiments may be combined.

In accordance with the provisions of the patent statutes, the present invention has been described in what is considered to represent its preferred embodiment. However, it should be noted that the invention can be practiced otherwise than as specifically illustrated and described without departing from its spirit or scope.

1-16. (canceled)

17. A method for operating an elevator for maintenance, wherein the elevator includes a car, an elevator shaft with the car being displaceable along the elevator shaft, a drive for displacing the car, a plurality of shaft doors, at least one of the shaft doors being arranged at each of multiple floors including a lowermost floor and an uppermost floor for opening and closing access to the car, and an elevator control unit, the method comprising the steps of:
the elevator control unit receives a start-maintenance-request sent by a technician;
the elevator control unit switches from a normal operation mode to a maintenance mode in response to the received start-maintenance-request;
the elevator control unit receives a stop-maintenance-request sent by the technician;
the elevator control unit checks whether a person is within a predefined danger zone; and
the elevator control unit switches from the maintenance mode back into the normal operation mode when the elevator control unit concludes there is no person within the predefined danger zone.

18. The method according to claim 17 wherein the technician sends the start-maintenance-request and the stop-maintenance-request from a mobile electronic device.

19. The method according to claim 17 wherein the predefined danger zone is at least a portion of the elevator shaft.

20. The method according to claim 17 wherein the step of checking whether a person is within the predefined danger zone comprises the steps of:
capturing a pre-maintenance-status of the elevator after the start-maintenance-request was received by the elevator control unit and before the elevator control unit switches from the normal operation mode to the maintenance mode and/or capturing a post-maintenance-status of the elevator after the stop-maintenance-request was received by the elevator control unit and before the elevator control unit switches from the maintenance mode back to the normal operation mode;
evaluating a difference between two statuses of the elevator by comparing the pre-maintenance-status of the elevator with the post-maintenance-status of the elevator, or comparing the pre-maintenance status with a predefined value for the pre-maintenance-status, or comparing the post-maintenance status with a predefined value for the post-maintenance-status; and
concluding that no person is in the predefined danger zone when the evaluated difference is below a predefined threshold.

21. The method according to claim 20 wherein the capturing of the pre-maintenance-status and the post-maintenance-status of the elevator includes measuring values for a pre-maintenance-load and a post-maintenance-load of the car and storing the values in the elevator control unit.

22. The method according to claim 20 wherein the capturing of the pre-maintenance-status and the post-maintenance-status of the elevator includes capturing a snapshot of the elevator shaft with at least one of a camera, a TOF-camera, a thermographic camera and a lidar system.

23. The method according to claim 17 wherein the step of checking whether a person is within the predefined danger zone includes at least one of the steps of:
verifying the technician is present within the car or on a floor after the elevator control unit receives the start-maintenance-request from the technician and before the elevator control unit switches from the normal operation mode to the maintenance mode; and
verifying the technician is present within the car or on a floor after the elevator control unit receives the stop-maintenance-request from the technician and before the elevator control unit switches from the maintenance mode back into the normal operation mode.

24. The method according to claim 23 wherein verifying the presence of the technician in the car or on a floor is performed by identifying the technician by at least one of:
displaying a code on a screen in the car and/or on the floor and requiring the technician to scan the code with a mobile electronic device; and
using a camera and/or a near field communication device in the car and/or on the floor to identify the technician.

25. The method according to claim 17 wherein the start maintenance-request sent by the technician is a request to enter the elevator shaft at a specific shaft door, and wherein the method includes a step of displacing the car to a pre-defined position in proximity of the specific shaft door.

26. The method according to claim 17 including a step of restricting displacement of the car in solely:
an upward direction when the maintenance mode was requested at the lowermost floor; and/or
a downward direction when the maintenance mode was requested at the uppermost floor after the stop-maintenance-request was received by the elevator control unit.

27. The method according to claim 17 wherein at least one of the shaft doors has an active door drive for opening and closing the at least one shaft door and/or an active door lock for locking and unlocking the at least one shaft door and wherein the method further comprises the steps of:
unlocking the at least one shaft door by the active door lock and/or opening the at least one shaft door by the active door drive thereby enabling the technician to access the elevator shaft after the maintenance mode was entered; and/or
closing the at least one shaft door by the active door drive and/or locking the at least one shaft door by the active door lock thereby preventing the technician access to the elevator shaft before the maintenance mode is left.

28. The method according to claim 17 including assuring that the car is empty after the elevator control unit receives the start-maintenance-request sent by the technician and before the elevator control unit switches from the normal operation mode to the maintenance mode.

29. The method according to claim 17 wherein in the maintenance mode, the elevator control unit prevents the drive from displacing the car and/or an elevator brake is engaged before the technician is granted access to the elevator shaft.

30. The method according to claim 17 including initiating verification of a braking capability after the maintenance mode was left and/or before maintenance mode is entered by performing a static brake test on a brake of the elevator.

31. An elevator comprising:
a car displaceable along an elevator shaft;
a drive for displacing the car along the elevator shaft;
an elevator control unit;
a plurality of shaft doors, at least one of the shaft doors being arranged at each of multiple floors, each of the shaft doors having an associated active door drive for opening and closing the shaft door and/or an active door lock that is enabled and disabled by the elevator control unit; and
wherein the elevator control unit is adapted to perform the method according to claim 17.

32. A computer program product comprising non-transitory computer readable instructions for performing the method according to claim 17, which instructions:
when executed by a processor in the elevator control unit instruct the elevator control unit to perform the method; and
when executed by a processor in a data communication device instruct the data communication device to transmit the start-maintenance-request and the stop-maintenance-request.

33. A computer readable medium comprising the computer program product according to claim 32 stored thereon.

34. A method for operating an elevator for maintenance, wherein the elevator includes a car, an elevator shaft with the car being displaceable along the elevator shaft, a drive for displacing the car, a plurality of shaft doors, each of the shaft doors being arranged at an associated one of multiple floors including a lowermost floor and an uppermost floor for opening and closing access to the car, and an elevator control unit, the method comprising the following steps:
the elevator control unit receives a start-maintenance-request sent by a technician using a mobile electronic device;
the elevator control unit switches from a normal operation mode to a maintenance mode in response to the received start-maintenance-request;
the elevator control unit receives a stop-maintenance-request sent by the technician using the mobile electronic device;
the elevator control unit checks whether a person is within a predefined danger zone in the elevator shaft; and
the elevator control unit switches from the maintenance mode back into the normal operation mode when the elevator control unit concludes there is no person within the predefined danger zone.

35. The method according to claim 34 wherein the step of checking whether a person is within the predefined danger zone comprises the steps of:
capturing a pre-maintenance-status of the elevator after the start-maintenance-request was received by the elevator control unit and before the elevator control unit switches from the normal operation mode to the maintenance mode and/or capturing a post-maintenance-status of the elevator after the stop-maintenance-request was received by the elevator control unit and before the elevator control unit switches from the maintenance mode back to the normal operation mode; and
evaluating a difference between two statuses of the elevator by,
evaluating a difference between the pre-maintenance-status of the elevator and the post-maintenance-status of the elevator and concluding that no person is in the predefined danger zone when the evaluated difference is below a predefined first threshold; and/or
evaluating a difference between the pre-maintenance-status of the elevator and a predefined value for the pre-maintenance-status and concluding that no person is in the predefined danger zone when the evaluated difference is below a predefined second threshold; and/or
evaluating a difference between the post-maintenance-status of the elevator and a predefined value for the post-maintenance-status and concluding that no person is in the predefined danger zone when the evaluated difference is below a predefined third threshold.
